(19) United States
(12) Patent Application Publication
(10) Pub. No.: US 2016/0154920 A1
(43) Pub. Date: Jun. 2, 2016

(54) DESIGN METHOD AND DESIGN APPARATUS

(71) Applicant: FUJITSU SEMICONDUCTOR LIMITED, Yokohama-shi (JP)

(72) Inventor: Norihiro HARADA, Kawagoe (JP)

(21) Appl. No.: 14/928,808

(22) Filed: Oct. 30, 2015

(30) Foreign Application Priority Data
Dec. 1, 2014 (JP) 2014-243352

(51) Int. Cl. G06F 17/50

(52) U.S. Cl. CPC G06F 17/5072

(57) ABSTRACT

A processor arranges a first dummy pattern in each of a plurality of circuit blocks of a first layer included in hierarchical design data of a semiconductor device; sets an arrangement candidate region as a candidate for arranging a second dummy pattern in a region, which is located between a circuit block boundary and the first dummy pattern and in which the first dummy pattern is not arranged, in each of the plurality of circuit blocks; arranges the plurality of circuit blocks in an upper-layer region of a second layer higher than the first layer; and arranges the second dummy pattern in a portion formed by joining a first arrangement candidate region of a first circuit block and a second arrangement candidate region of a second circuit block, which contact each other, among the arrangement candidate regions of the plurality of circuit blocks arranged in the upper-layer region.

### CROSS-REFERENCE TO RELATED APPLICATION

This application is based upon and claims the benefit of priority of the prior Japanese Patent Application No. 2014-243352, filed on Dec. 1, 2014, the entire contents of which are incorporated herein by reference.

### FIELD

The embodiments discussed herein relate to design methods and design apparatuses.

### BACKGROUND

If a difference in density of the wiring patterns or the like on a substrate or on a circuit block (also referred to as a cell etc.) is large in designing a semiconductor device, a density error may occur in DRC (Design Rule Checking) verification, thus not allowing the semiconductor device to be manufactured. Moreover, even when a density error does not occur, a step may be produced in the surface of a semiconductor device due to the difference in density, for example. As a result, an uncut wiring may be produced in CMP (Chemical Mechanical Polish), and cause a defect, such as short, resulting in worse yield.

Then, in order to reduce the difference in density, a technique is known for arranging a dummy pattern.

See, for example, Japanese Laid-open Patent Publication No. 2001-166452; Japanese Laid-open Patent Publication No. 2008-305814; and Japanese Laid-open Patent Publication No. 2011-22831.

During hierarchical design, there is not a sufficient width for arranging a dummy pattern in the vicinity of a boundary of a circuit block, and therefore a region is formed in which a dummy pattern is not arranged. When the regions are arranged in an upper layer so that the regions contact with each other among a plurality of circuit blocks, a region in which a dummy pattern is not arranged will expand and a density error might occur in DRC verification. If a density error occurs, there is a problem that a rework in design, such as the modification of a layout, will occur to increase the design period.

### SUMMARY

According to one aspect, there is provided a design method including: arranging, by a processor, a first dummy pattern in each of a plurality of circuit blocks of a first layer included in hierarchical design data of a semiconductor device; setting, by the processor, an arrangement candidate region that is a candidate for arranging a second dummy pattern in a first region, which is located between a circuit block boundary and the first dummy pattern and in which the first dummy pattern is not arranged, in each of the plurality of circuit blocks; arranging, by the processor, the plurality of circuit blocks in a second region of a second layer higher than the first layer; and arranging, by the processor, the second dummy pattern in a portion formed by joining a first arrangement candidate region of a first circuit block and a second arrangement candidate region of a second circuit block, the first arrangement candidate region and the second arrangement candidate region being in contact with each other, among arrangement candidate regions of the plurality of circuit blocks arranged in the second region.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a design method of a first embodiment;

FIG. 2 illustrates an example of a circuit block in which an arrangement candidate region is not provided;

FIG. 3 illustrates an example where the circuit block in which an arrangement candidate region is not provided is arranged into an upper-layer region;

FIG. 4 illustrates an example of hardware of a design apparatus of a second embodiment;

FIG. 5 is a flowchart illustrating an exemplary flow of a design method of the second embodiment;

FIG. 6 is a flowchart illustrating an exemplary flow of generating an arrangement candidate region;

FIG. 7 illustrates an example of a circuit block in which a circuit pattern is arranged;

FIG. 8 illustrates an example of an enlarged circuit pattern;

FIG. 9 illustrates an example of the arrangement of a dummy pattern;

FIG. 10 illustrates an example of a dummy pattern to be arranged in a circuit block, among the dummy patterns in a dummy pattern region;

FIG. 11 illustrates an example where composite pattern exceeds a circuit block boundary;

FIG. 12 illustrates an example where an enlarged composite pattern does not exceed a circuit block boundary;

FIG. 13 illustrates an example of a circuit block in which an arrangement candidate region is generated;

FIG. 14 is a flowchart illustrating an exemplary flow of arranging a dummy pattern in an upper-layer region;

FIG. 15 is a flowchart illustrating an exemplary flow of generating a dummy pattern for an arrangement candidate region;

FIG. 16 illustrates a first layout example of an upper-layer region;

FIG. 17 is a partially enlarged view of FIG. 16;

FIG. 18 illustrates a second layout example of an upper-layer region;

FIG. 19 is a partially enlarged view of FIG. 18;

FIG. 20 illustrates a first example of displaying design data on a screen of a monitor; and

FIG. 21 illustrates a second example of displaying design data on the screen of the monitor.

### DESCRIPTION OF EMBODIMENTS

Several embodiments will be described below with reference to the accompanying drawings, wherein like reference numerals refer to like elements throughout.

### First Embodiment

The design method of the embodiment is for designing a semiconductor device by a computer.

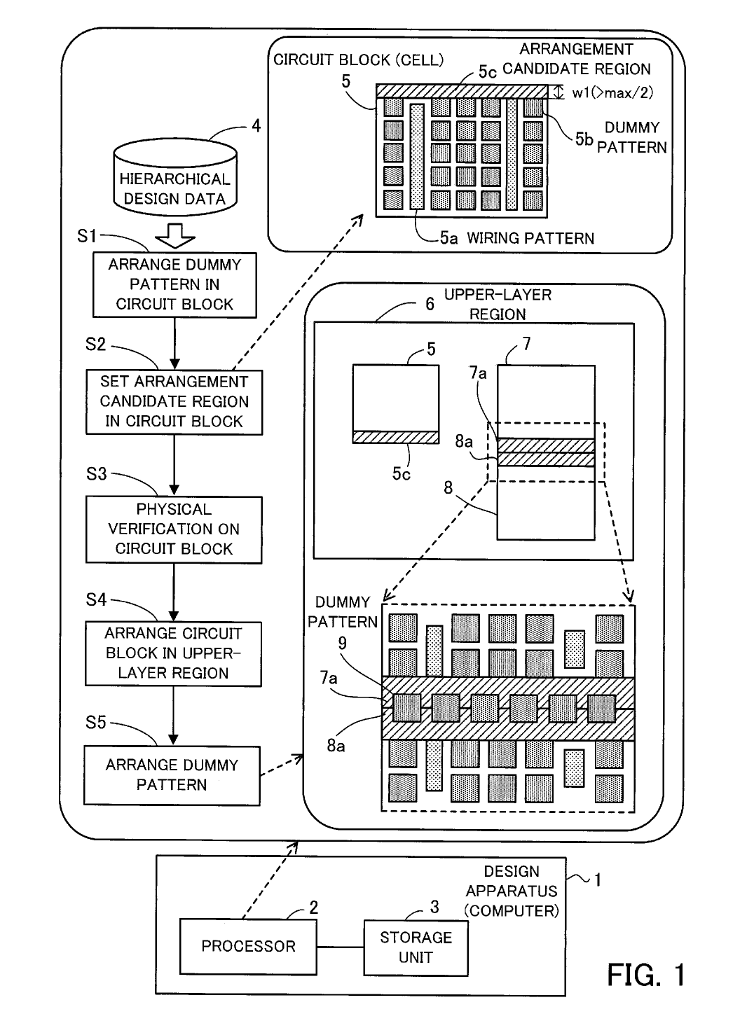

FIG. 1 illustrates an example of a design method of a first embodiment.

The design method is performed by a design apparatus 1 below.

The design apparatus 1 is a computer, for example, and includes a processor 2 and a storage unit 3. The processor 2 performs a following procedure based on the data and program stored in the storage unit 3.

The storage unit 3 stores the programs executed by the processor 2 and various types of data. For example, the storage unit 3 stores hierarchical design data 4 of a semiconductor device.

The hierarchical design data 4 includes the layout design data of a circuit block (cell) and the layout design data of a region of an upper layer in which the circuit block is arranged. The hierarchical design data 4 is described in the format of GDS (Graphic Data

System), OASIS (Open Artwork System Interchange Standard), or the like, for example.

In the design method of the first embodiment, first, the processor 2 reads the hierarchical design data 4 from the storage unit 3 and arranges a dummy pattern in each of a plurality of circuit blocks of a first layer (hereinafter, referred to as a lower layer) included in the hierarchical design data 4 (step S1). The processor 2 arranges, as described later, a dummy pattern of a predetermined size in a portion, in which a wiring pattern and the like of a circuit block are not arranged, at a fixed interval from the lower left toward the upper right, for example, with the lower-left vertex of the circuit block as the starting point.

The dummy pattern is, for example, a pattern that is arranged so as to make constant the density of circuit patterns (wiring patterns, diffusion region patterns, polysilicon gate patterns, or the like) included in a circuit block. The dummy pattern is formed, for example, from the same material as the material of a circuit pattern, during manufacturing.

Next, the processor 2 sets an arrangement candidate region that is a candidate for arranging a dummy pattern in an upper layer, in a region, which is located between a circuit block boundary (cell frame) and a dummy pattern and in which a dummy pattern is not arranged, in each of a plurality of circuit blocks (step S2).

An example of a circuit block 5 is illustrated in FIG. 1. The circuit block 5 includes a wiring pattern 5a and a dummy pattern 5b that is arranged in step S1. Moreover, an arrangement candidate region 5c is set in a region between a boundary (an upper side of the circuit block 5 in the example of FIG. 1) of the circuit block 5 and the dummy pattern 5b.

Subsequently, the processor 2 performs physical verification, such as DRC, of the circuit block (step S3). The processor 2 determines whether or not a density error has occurred, as the physical verification, for example. When in the circuit block, the width of a region (hereinafter, referred to as a blank region), in which there is neither a circuit pattern nor a dummy pattern, exceeds a predetermined value, a density error occurs. Once a density error occurs, the layout of a circuit block is modified.

Next, the processor 2 arranges a circuit block in a region of an upper layer (hereinafter, referred to as an upper-layer region) relative to a lower layer (step S4). Subsequently, the processor 2 arranges a dummy pattern in a portion formed by joining arrangement candidate regions of two circuit blocks in contact with each other among the respective arrangement candidate regions of the circuit blocks arranged in the upper-layer region (step S5). Moreover, in this case, the processor 2 arranges a dummy pattern also in a region, in which a circuit block and the like of an upper-layer region are not arranged.

An example of an upper-layer region 6 is illustrated in FIG. 1. In the upper-layer region 6, the circuit blocks 5, 7, and 8 are arranged in step S4. The circuit blocks 7 and 8 are arranged so that the respective arrangement candidate regions 7a and 8a thereof contact with each other. Then, a dummy pattern 9 is arranged in a portion formed by joining the arrangement candidate regions 7a and 8a. The processor 2 arranges, as illustrated in FIG. 1, in step S5, a dummy pattern having the same size as the size of a dummy pattern arranged in the circuit blocks 7 and 8, at a fixed interval, with the lower-left vertex of the arrangement candidate regions 7a and 8a as the starting point, for example.

Hereinafter, prior to describing the effect of the design method of the first embodiment, an example is described where a circuit block, in which the arrangement candidate region as described above is not provided, is arranged in an upper-layer region.

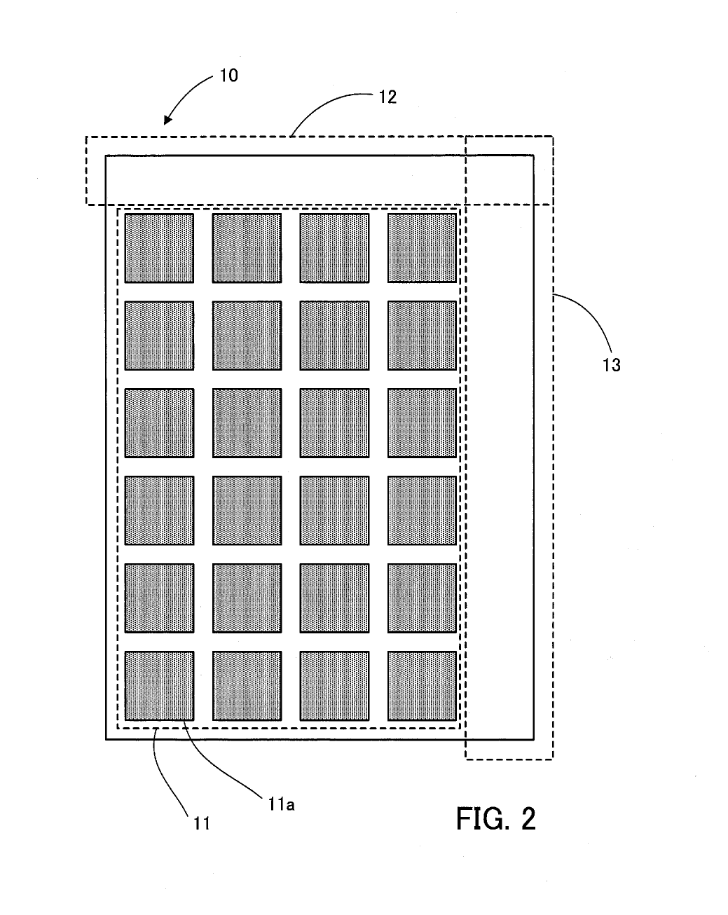

FIG. 2 illustrates an example of a circuit block in which an arrangement candidate region is not provided.

A dummy pattern group 11 is arranged in a circuit block 10. Each dummy pattern (e.g., dummy pattern 11a) of a predetermined size in the dummy pattern group 11 is arranged at a fixed interval, with the lower-left vertex of the circuit block 10 as the starting point.

Due to such an arrangement, the width for arranging a dummy pattern is insufficient in the vicinity of a boundary of the circuit block 10, and therefore blank regions 12 and 13, in which a dummy pattern is not arranged, are produced.

An example where such a circuit block is arranged in an upper-layer region is described below.

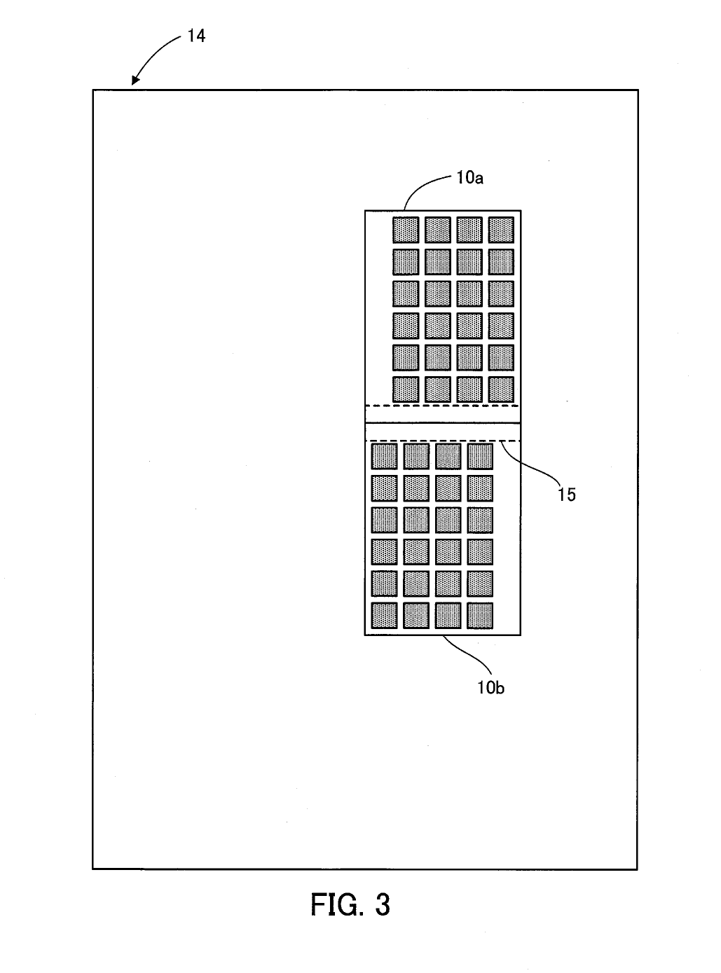

FIG. 3 illustrates an example where a circuit block in which an arrangement candidate region is not provided is arranged into an upper-layer region.

Circuit blocks 10a and 10b are arranged in an upper-layer region 14. The circuit blocks 10a and 10b are arranged in the upper-layer region 14 so that relatively wide blank regions (e.g., blank region 12 of FIG. 2) contact each other. In this case, in the upper-layer region 14, a wider blank region 15 is produced and a density error might occur.

Here, when the processor 2 arranges a dummy pattern in the upper-layer region 14, a dummy pattern of a predetermined size is arranged at a fixed interval, with the lower-left vertex of the upper-layer region 14 as the starting point, for example. Therefore, depending on a relationship between the interval of dummy patterns to be arranged and the width of the blank region 15, a dummy pattern is not arranged. In this case, a density error occurs, and for example, the layout is modified in order to resolve the error, resulting in a rework in design.

Note that, in order to suppress the occurrence of a density error, a smaller dummy pattern might be arranged in the vicinity of a boundary of a circuit block. However, in handling such a plurality of different types of dummy patterns by automatic layout, the algorithm for generating the dummy patterns becomes complicated, and therefore the dummy patterns need to be manually arranged. As a result, the design period increases.

In contrast, in the design method of the embodiment, an arrangement candidate region for a dummy pattern is set in the boundary portion of each circuit block, and the dummy pattern is arranged in a portion formed by joining the arrangement candidate regions in contact with each other between circuit blocks, so that the occurrence of a density error is suppressed. Therefore, the rework in design is reduced and the design period may be reduced. Moreover, there is no need to handle a plurality of different types of dummy patterns, and therefore the algorithm will not be complicated.

Note that, in the above step S2, the processor determines, based on an allowable maximum width (hereinafter, referred to as a check value) of a blank region specified by a rule of DRC, whether or not to set an arrangement candidate region, so that a density error may be more efficiently suppressed.

For example, when in at least one of two circuit blocks, the width of a blank region of a boundary portion exceeds a half of the check value, once blank regions are arranged so as to contact each other, a total width of the two blank regions does not satisfy the check value and a density error may occur. Therefore, an arrangement candidate region is set in a blank region whose width exceeds a half of the check value, where a density error is likely to occur when a circuit block is arranged in an upper-layer region, so that a density error may be efficiently suppressed.

In the example of the circuit block 5 illustrated in FIG. 1, the arrangement candidate region 5c is set in the blank region whose width w1 exceeds a half (represented by max/2) of the check value.

### Second Embodiment

Hereinafter, an example of the design method and design apparatus of a second embodiment is illustrated.

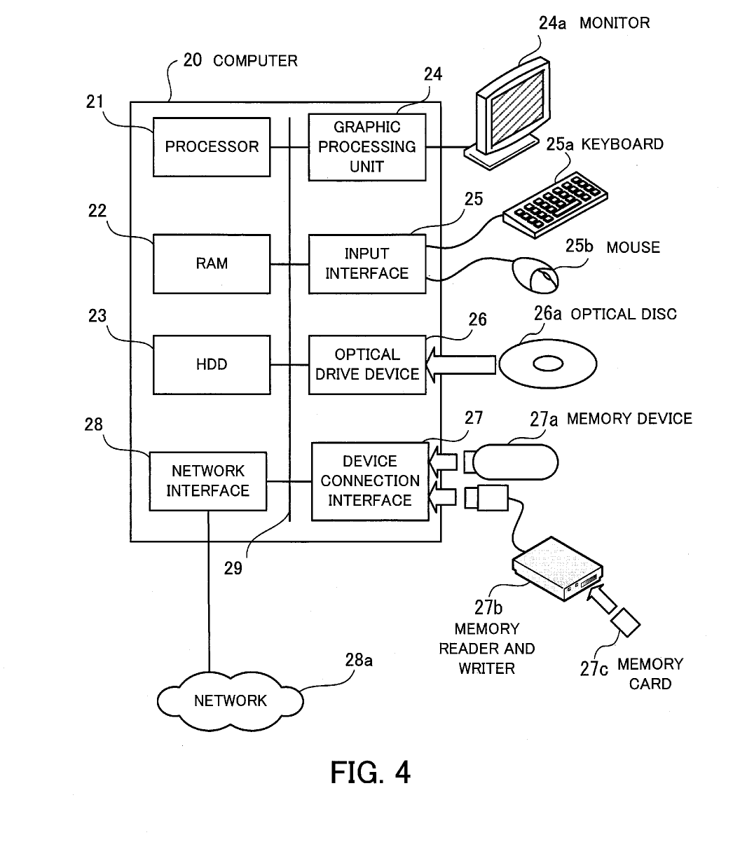

FIG. 4 illustrates an example of hardware of the design apparatus of the second embodiment.

The design apparatus is a computer 20, for example, and the whole apparatus is controlled by a processor 21. A RAM (Random Access Memory) 22 and a plurality of peripheral devices are connected to the processor 21 via a bus 29. The processor 21 may be a multiprocessor. The processor 21 may be, for example, a CPU (Central Processing Unit), an MPU (Micro Processing Unit), a DSP (Digital Signal Processor), an ASIC (Application Specific Integrated Circuit), or a PLD (Programmable Logic Device). Moreover, the processor 21 may be a combination of two or more of the CPU, MPU, DSP, ASIC, and PLD.

The RAM 22 is used as a main storage device of the computer 20. At least a part of a program of an OS (Operating System) and application program executed by the processor 21 is temporarily stored onto the RAM 22. Moreover, various types of data needed for processing by the processor 21 are stored on the RAM 22.

The peripheral devices connected to the bus 29 include an HDD (Hard Disk Drive) 23, a graphic processing unit 24, an input interface 25, an optical drive device 26, a device connection interface 27, and a network interface 28.

The HDD 23 magnetically writes and reads data to and from a built-in disk. The HDD 23 is used as an auxiliary storage device of the computer 20. The program of an OS, application programs, and various types of data are stored on the HDD 23. Note that a semiconductor storage device, such as a flash memory, may be used as the auxiliary storage device.

A monitor 24a is connected to the graphic processing unit 24. The graphic processing unit 24 displays an image on a screen of the monitor 24a in accordance with an instruction from the processor 21. The examples of the monitor 24a include a display apparatus using a CRT (Cathode Ray Tube) and a liquid crystal display device.

A keyboard 25a and a mouse 25b are connected to the input interface 25. The input interface 25 transmits a signal sent from the keyboard 25a or the mouse 25b to the processor 21. Note that the mouse 25b is an example of the pointing device and thus other pointing devices may be used. The examples of the other pointing devices include a touch panel, a tablet, a touchpad, and a trackball.

The optical drive device 26 reads the data recorded on the optical disc 26a using a laser beam or the like. The optical disc 26a is a portable recording medium on which data is recorded so as to be readable by reflection of light. The examples of the optical disc 26a include a DVD (Digital Versatile Disc), a DVD-RAM, a CD-ROM (Compact Disc Read Only Memory), and a CD-R (Recordable)/RW (ReWritable).

The device connection interface 27 is the communication interface for connecting peripheral devices to the computer 20. For example, a memory device 27a and a memory reader and writer 27b may be connected to the device connection interface 27. The memory device 27a is a recording medium having a function to communicate with the device connection interface 27. The memory reader and writer 27b is an apparatus that writes data to the memory card 27c or that reads the data from the memory card 27c. The memory card 27c is a card-type recording medium.

The network interface 28 is connected to the network 28a. The network interface 28 transmits and receives data to and from another computer or telecommunication device via the network 28a.

With such a hardware configuration, the design method of the second embodiment may be realized. Note that the design apparatus 1 of the first embodiment illustrated in FIG. 1 may be also realized with hardware similar to the hardware of the computer 20 illustrated in FIG. 2.

The computer 20 realizes the processing functions of the second embodiment by executing programs recorded on a computer readable recording medium, for example. A program describing the processing content executed by the computer 20 may be recorded on various recording media. For example, the programs executed by the computer 20 may be stored on the HDD 23. The processor 21 loads at least a part of programs inside the HDD 23 onto the RAM 22, and executes the programs. Moreover, a program executed by the computer 20 may be recorded on portable recording media, such as the optical disc 26a, memory device 27a, or memory card 27c. A program stored on a portable recording medium is installed on the HDD 23 under the control of the processor 21 and then allowed to be executed. Moreover, the processor 21 may read the program directly from the portable recording medium and execute the same.

Next, an example of the design method of the embodiment is described.

(Design Method)

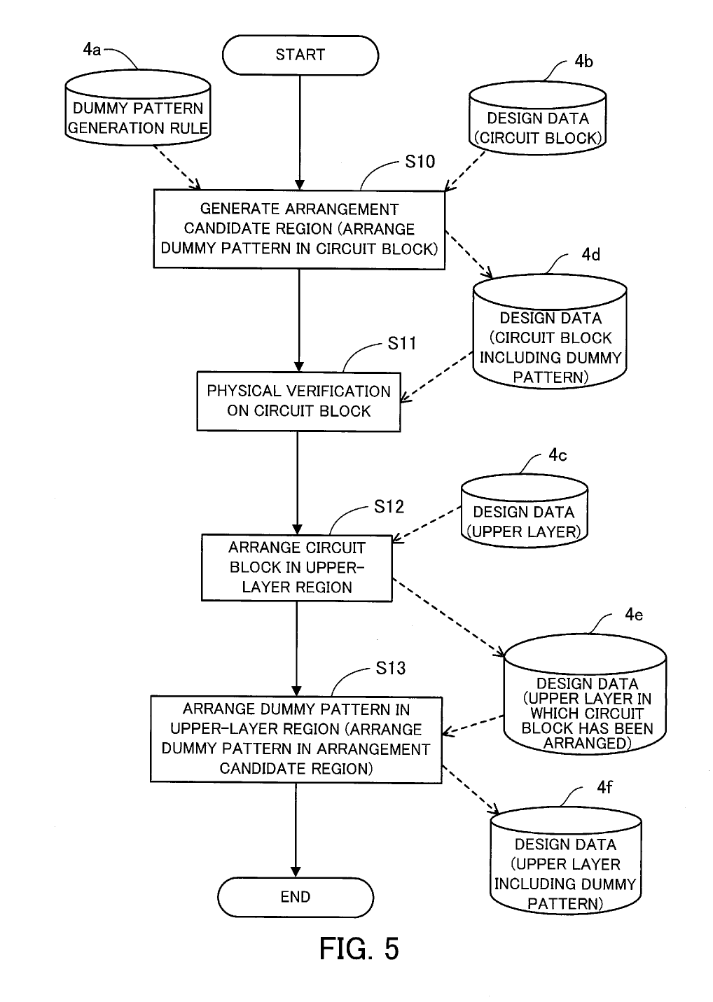

FIG. 5 is a flowchart illustrating an exemplary flow of a design method of the second embodiment.

The following procedure is performed by the computer 20 illustrated in FIG. 4 under the control of the processor 21 based on a dummy pattern generation rule 4a and design data 4b and 4c that are stored on the HDD 23 in advance.

The design data 4b is the data including the layout design data of a circuit block in a lower layer.

The design data 4c is the data including the layout design data of an upper-layer region. The upper-layer region is designed taking into consideration the timing constrains on a signal and the like between circuit blocks when the circuit blocks are arranged.

The dummy pattern generation rule 4a includes a dummy pattern arrangement rule and the check value in generating an arrangement candidate region. The examples of the dummy pattern arrangement rule include the size of a dummy pattern and the arrangement interval between dummy patterns.

First, the processor 21 reads the dummy pattern generation rule 4a and design data 4b from the HDD 23. Then, based on the read dummy pattern generation rule 4a and design data 4b, the processor 21 arranges a dummy pattern in a circuit block and generates an arrangement candidate region in the circuit block (step S10).

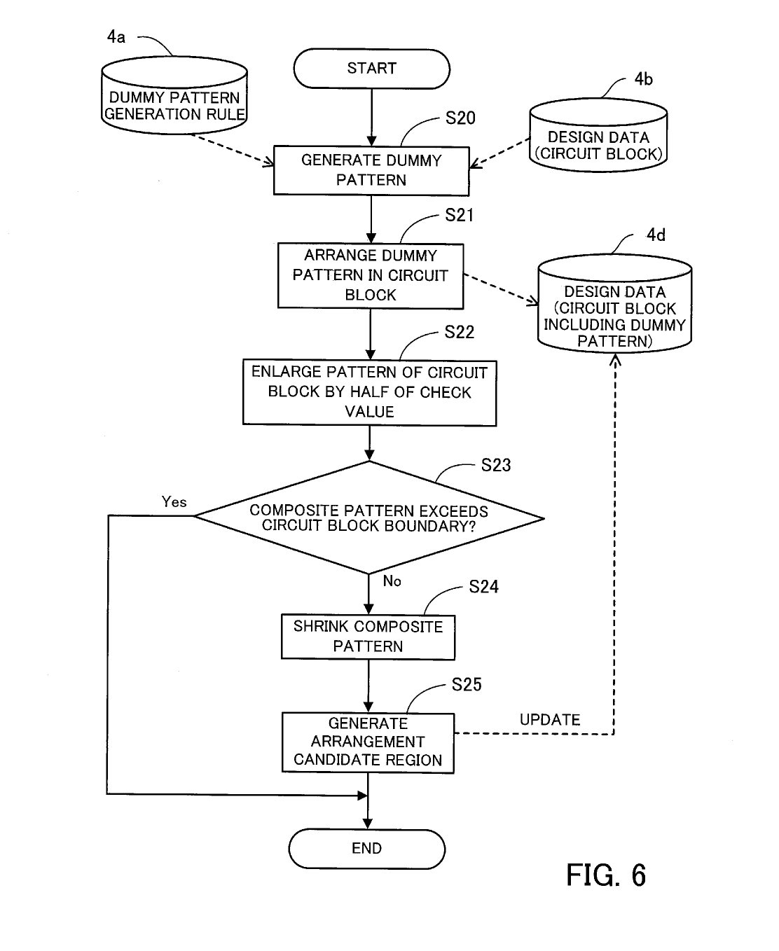

FIG. 6 is a flowchart illustrating an exemplary flow of generating an arrangement candidate region.

First, based on the dummy pattern generation rule 4a and design data 4b, the processor 21 generates a dummy pattern to be arranged in a circuit block (step S20).

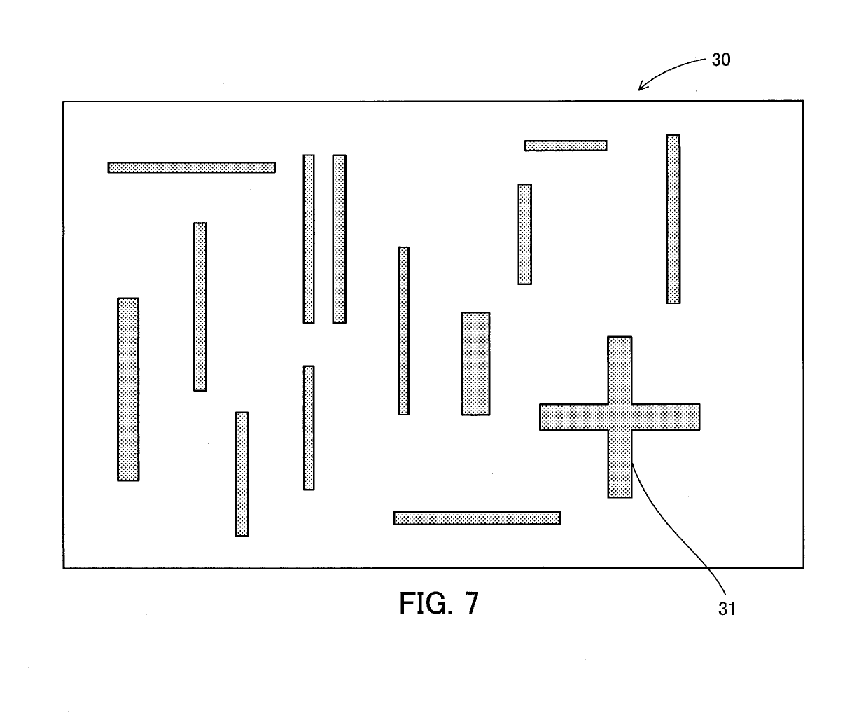

Hereinafter, an example of generating a dummy pattern is described using FIGS. 7 to 10.

FIG. 7 illustrates an example of a circuit block in which a circuit pattern is arranged.

The circuit pattern includes a wiring pattern, a polysilicon pattern, and the like that are not a dummy pattern.

The processor 21 enlarges each circuit pattern (pattern 31 or the like) by the same size as the minimum reference value of the interval between a circuit pattern and a dummy pattern that is determined by the dummy pattern generation rule 4a in advance.

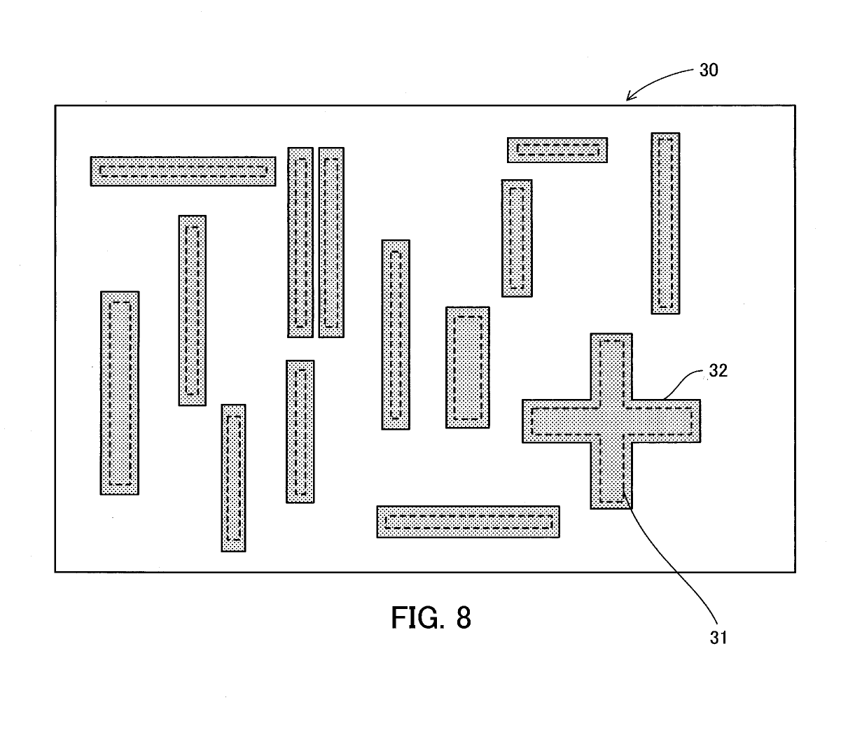

FIG. 8 illustrates an example of the enlarged circuit pattern.

Note that, among the elements illustrated in FIG. 8, the same element as the element illustrated in FIG. 7 is given the same reference numeral.

A pattern 32 illustrated in FIG. 8 is an enlarged version of the pattern 31 illustrated in FIG. 7.

Next, the processor 21 sets a region of the same size as the size of the circuit block, and arranges, in the region, a dummy pattern of a predetermined size at a fixed interval.

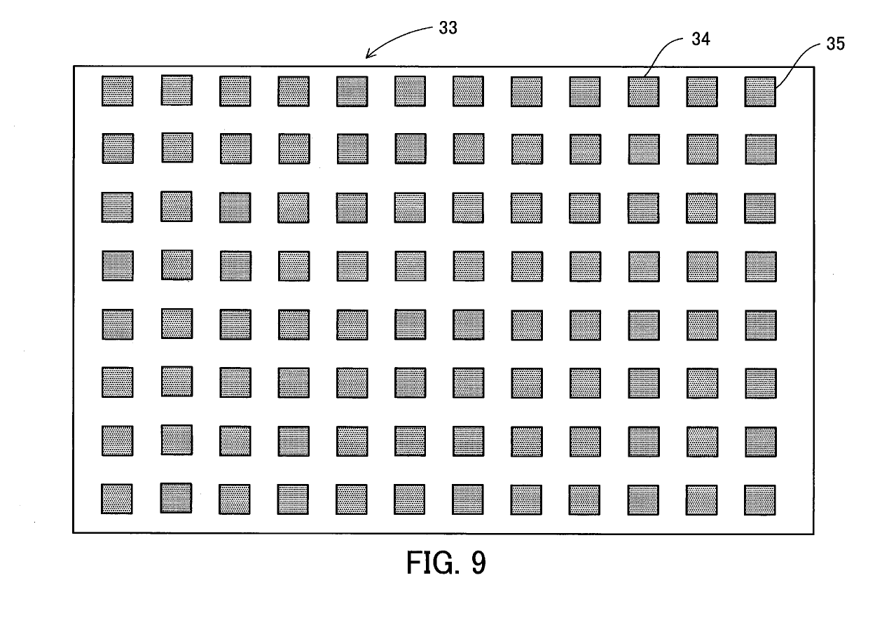

FIG. 9 illustrates an example of the arrangement of the dummy pattern.

A dummy pattern region 33 illustrated in FIG. 9 has the same size as the circuit block 30 illustrated in

FIGS. 7 to 8. In the dummy pattern region 33, dummy patterns (e.g., dummy patterns 34 and 35) of a predetermined size are arranged at a fixed interval, with the lower-left vertex of the dummy pattern region 33 as the starting point.

Subsequently, the processor 21 superposes the dummy pattern region 33 illustrated in FIG. 9 on the circuit block 30 illustrated in FIG. 8. Then, the processor 21 deletes a dummy pattern in contact with the enlarged circuit pattern, among the dummy patterns in the dummy pattern region 33. As a result, the dummy patterns to be arranged in the circuit block 30 are determined.

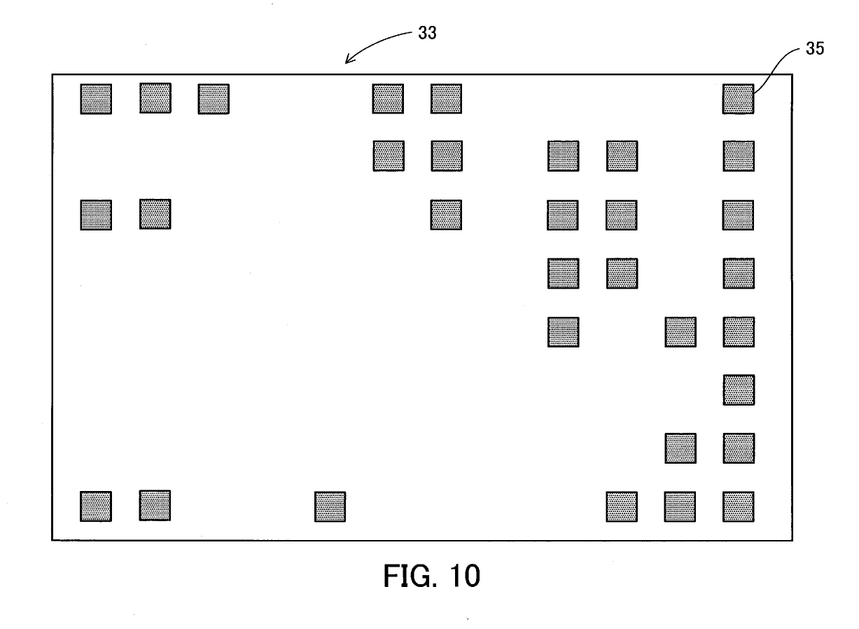

FIG. 10 illustrates an example of dummy patterns to be arranged in the circuit block, among the dummy patterns in the dummy pattern region.

Note that, among the elements illustrated in FIG. 10, the same element as the element illustrated in FIG. 9 is given the same reference numeral to omit the description thereof.

In FIG. 10, an example is illustrated where the dummy pattern 34 illustrated in FIG. 9 is deleted because it touches the enlarged circuit pattern of the circuit block 30 illustrated in FIG. 8.

In this manner, the dummy patterns to be arranged in a circuit block are obtained.

Returning to FIG. 6, the processor 21 arranges the dummy pattern, which is generated in step S20, in the circuit block (step S21). As a result, design data 4d that is the layout design data, in which dummy patterns are arranged in the circuit block, is generated.

Next, in determining whether or not to generate an arrangement candidate region for a dummy pattern in a boundary portion of the circuit block, the processor 21 performs the following procedure, for example.

First, the processor 21 enlarges the circuit pattern and dummy pattern (hereinafter, simply referred to as a pattern) arranged in the circuit block, by a half of the check value (step S22). The check value is the allowable maximum width of a blank region as described above, and is set based on an allowable range of the pattern density in an upper-layer region, for example. Note that the patterns to be enlarged do not need to be all the patterns inside the circuit block. The processor 21 may select and enlarge patterns located in a vicinity portion of a circuit block boundary.

Next, the processor 21 determines whether or not the enlarged pattern exceeds the circuit block boundary (step S23). In step S23, the processor 21, for example, generates a composite pattern by combining (merging) the enlarged patterns and determines whether or not the composite pattern exceeds the circuit block boundary.

The processor 21 completes the procedure without generating an arrangement candidate region, when the composite pattern exceeds the circuit block boundary.

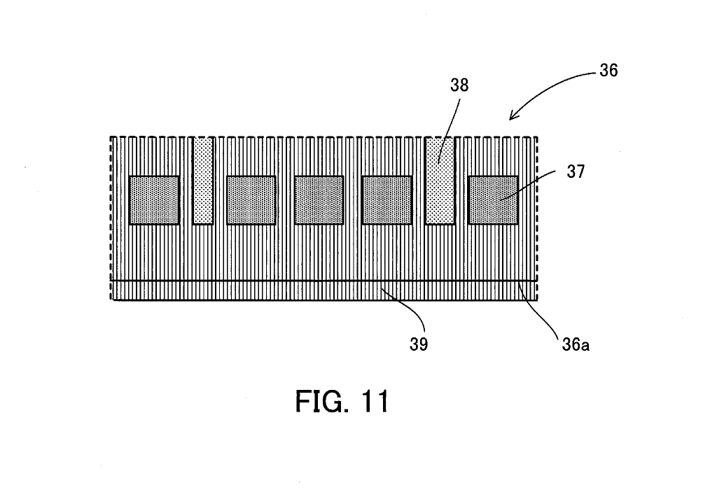

FIG. 11 illustrates an example where a composite pattern exceeds a circuit block boundary.

In FIG. 11, the vicinity portion of one side 36a among four sides of a circuit block 36 is illustrated. In the vicinity portion of the side 36a, a dummy pattern and a circuit pattern 38 are arranged. A composite pattern 39 is generated by the processor 21 merging the enlarged dummy pattern 37 and circuit pattern 38.

In the example of FIG. 11, the distance between the side 36a and the pattern (dummy pattern 37 and circuit pattern 38) is relatively short, and therefore the composite pattern 39 exceeds the side 36a of the circuit block 36 (i.e., the boundary of the circuit block 36).

The fact that the composite pattern 39 exceeds the side 36a means that even if the side 36a contacts another circuit block in arranging the circuit block 36 into an upper-layer region, the possibility that a wide blank region exceeding the check value is produced is relatively low. Therefore, the processor 21 will not generate an arrangement candidate region.

On the other hand, when the composite pattern does not exceed a circuit block boundary, the processor 21 performs step S24.

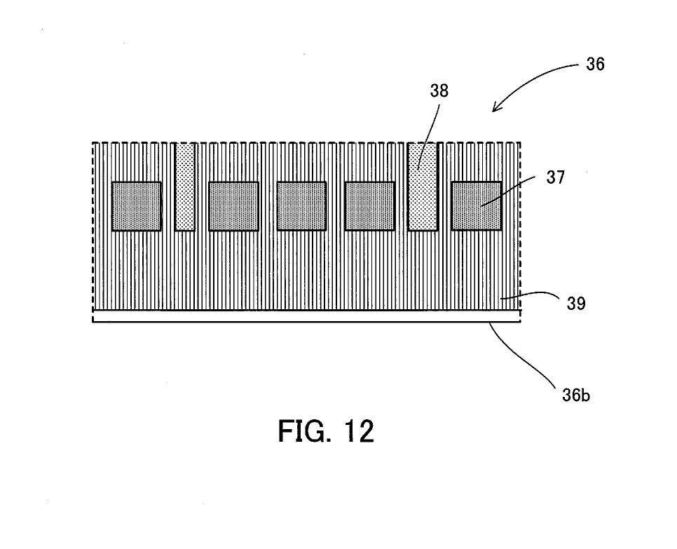

FIG. 12 illustrates an example where an enlarged composite pattern does not exceed a circuit block boundary. Note that, among the elements illustrated in FIG. 12, the same element as the element of FIG. 11 is given the same reference numeral to omit the description thereof.

In the example of FIG. 12, the distance between a side 36b and the pattern (dummy pattern 37 and circuit pattern 38) is relatively long, and therefore the composite pattern 39 does not exceed the side 36b of the circuit block 36.

The fact that the composite pattern 39 does not exceed the side 36b means that when the side 36b contacts another circuit block in arranging the circuit block 36 into an upper-layer region, the possibility that a wide blank region exceeding the check value is produced is relatively high.

In step S24, the processor 21 shrinks the composite pattern by a half of the check value. Then, the processor 21 generates an arrangement candidate region in a region, in which there is no pattern, between the circuit block boundary and the pattern (step S25). Moreover, the processor 21 updates the design data 4d based on the layout design data of the circuit block after generating the arrangement candidate region.

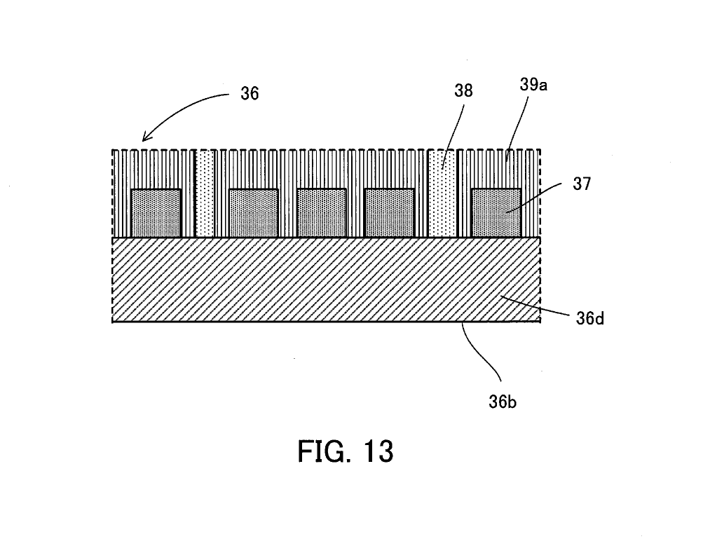

FIG. 13 illustrates an example of a circuit block in which an arrangement candidate region is generated. Note that, among the elements illustrated in FIG. 13, the same element as the element illustrated in FIG. 12 is given the same reference numeral to omit the description thereof.

In a portion between the side 36b of the circuit block 36 and a shrunk composite pattern 39a illustrated in FIG. 13, an arrangement candidate region 36d is set in step S25. The processor 21 may set, as the arrangement candidate region 36d, a portion that excludes the composite pattern 39a from the circuit block 36.

After generating the arrangement candidate regions as described above, step S11 in FIG. 5 is performed.

In step S11, the processor 21 performs physical verification of a circuit block. The processor 21 determines whether or not a density error has occurred, as the physical verification, for example. If in a circuit block, the width of a blank region exceeds the check value, a density error will occur. When a density error occurs, the layout of a circuit block is modified and step S10 is performed again.

After physical verification, the processor 21 reads the design data 4c from the HDD 23, and arranges the circuit block in an upper-layer region (step S12). As a result, design data 4e that is the layout design data, in which the circuit block is arranged in the upper-layer region, is generated.

Subsequently, the processor 21 arranges a dummy pattern in the upper-layer region (step S13).

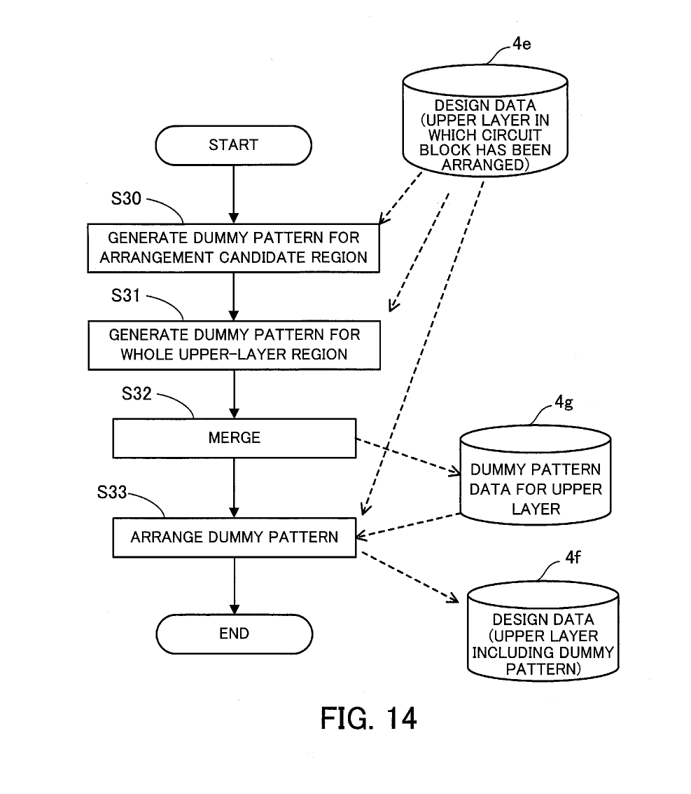

FIG. 14 is a flowchart illustrating an exemplary flow of arranging a dummy pattern in an upper-layer region.

Based on the design data 4e, the processor 21 generates a dummy pattern for an arrangement candidate region and a dummy pattern for the whole upper-layer region (steps S30 and S31). Subsequently, the processor 21 merges the dummy patterns generated in steps S30 and S31 to generate dummy pattern data 4g for an upper layer (step S32). Then, based on the design data 4e and the dummy pattern data 4g for an upper layer that is generated in step S32, the processor 21 arranges a dummy pattern in an upper-layer region and generates design data 4f of an upper layer including the dummy pattern (step S33).

Note that, with regard to steps S30 and S31 described above, either of them may be performed first or the both may be performed in parallel.

Hereinafter, an example of step S30 in FIG. 14 is described.

Step S30 is performed as follows, for example.

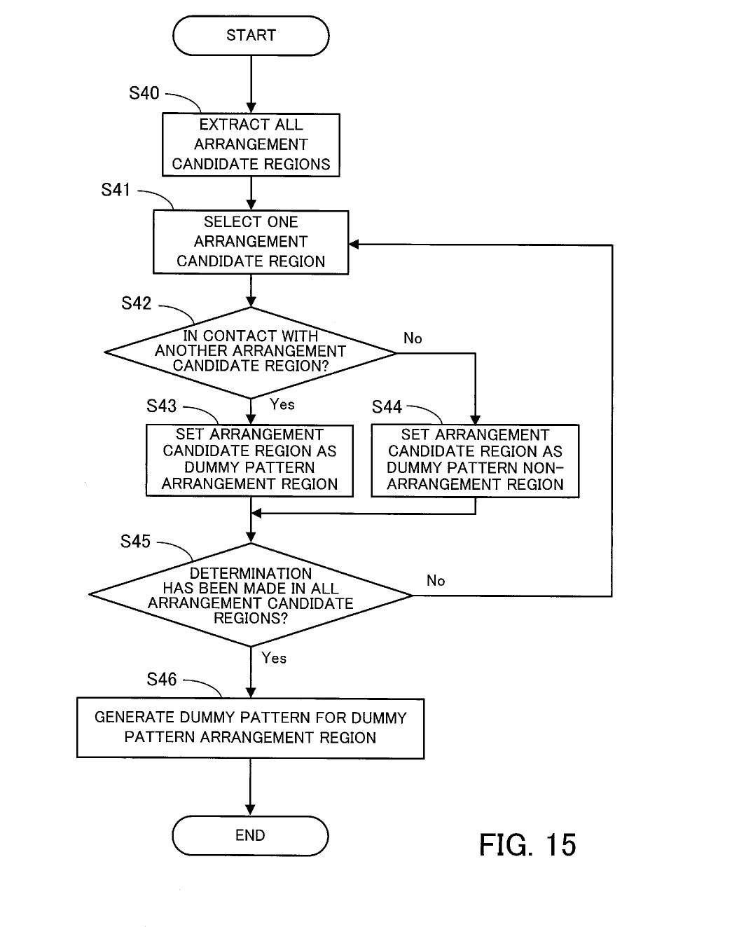

FIG. 15 is a flowchart illustrating an exemplary flow of generating a dummy pattern for an arrangement candidate region.

First, the processor 21 extracts, from the design data 4e, all the arrangement candidate regions for a circuit block arranged in the upper-layer region (step S40), and selects one arrangement candidate region from all the extracted arrangement candidate regions (step S41).

Next, the processor 21 determines whether or not the selected arrangement candidate region contacts another arrangement candidate region (step S42). When the selected arrangement candidate region is in contact with another arrangement candidate region, the processor 21 performs step S43, and sets the arrangement candidate region as a region in which a dummy pattern is to be arranged (hereinafter, referred to as a dummy pattern arrangement region).

On the other hand, when the selected arrangement candidate region is not in contact with another arrangement candidate region, the processor 21 performs step S44, and sets the arrangement candidate region as an arrangement candidate region in which a dummy pattern will not be arranged (hereinafter, referred to as a dummy pattern non-arrangement region). That is, the processor 21 excludes an arrangement candidate region that is not in contact with another arrangement candidate region, from the candidates for arranging a dummy pattern.

Subsequently, the processor 21 determines whether or not the determination in step S42 has been made in all the arrangement candidate regions (step S45); When the processor 21 determined that the determination in step S42 has not been done yet in all the arrangement candidate regions, the processor 21 will repeatedly perform the procedure from step S41. On the other hand, when the processor 21 determined that the determination processing of step S42 has been done in all the arrangement candidate regions, the processor 21 will perform step S46.

In step S46, the processor 21 generates a dummy pattern for a dummy pattern arrangement region. The processor 21 generates a dummy pattern of a predetermined size to be arranged at a fixed interval, with the lower-left vertex of the dummy pattern arrangement region as the starting point, for example.

In this manner, step S30 is completed.

In step S31, the processor 21 generates a dummy pattern for the whole upper-layer region, as with the above-described step S20 (see FIG. 6), for example. In step S32, the dummy patterns that are generated in steps S30 and S31 are merged. When a dummy pattern generated for the whole upper layer overlaps with a dummy pattern of a circuit block and/or a dummy pattern generated for a dummy pattern arrangement region in merging, the dummy pattern generated for the whole upper layer is deleted.

With such merging, the dummy pattern data 4g for an upper layer is generated. Then, by step S33, a dummy pattern is arranged into an upper-layer region and the design data 4f is generated.

Hereinafter, two layout examples indicated by the design data 4f generated by the design method of the embodiment are illustrated.

(First Layout Example)

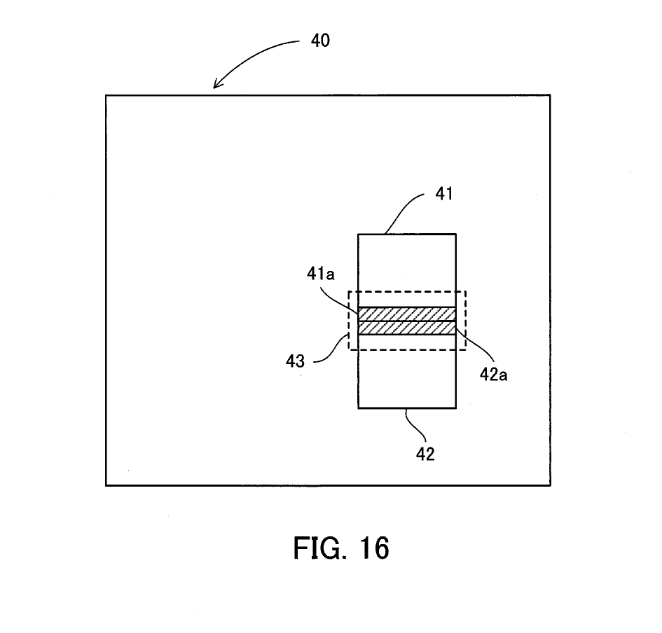

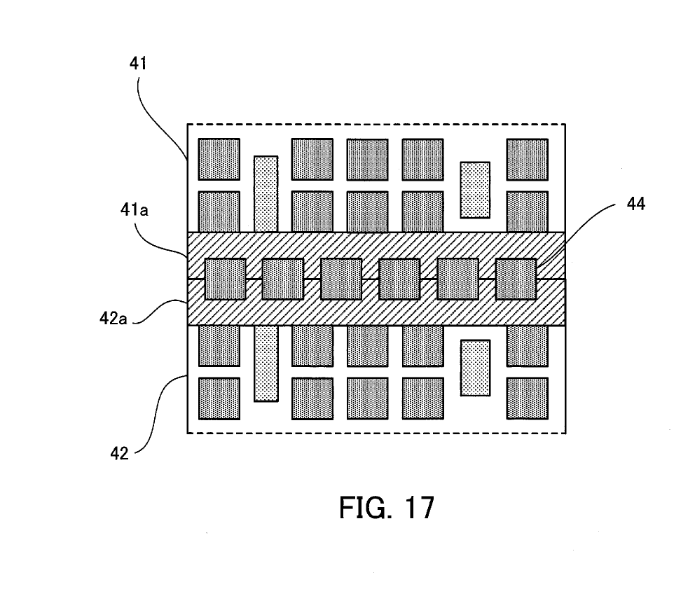

FIG. 16 illustrates a first layout example of an upper-layer region, and FIG. 17 is a partially enlarged view of FIG. 16. Note that FIG. 17 is an enlarged view of a region 43 illustrated in FIG. 16. In an upper-layer region 40 illustrated in FIG. 16, the illustration of patterns (circuit pattern and dummy pattern) is omitted.

As illustrated in FIG. 16, circuit blocks 41 and 42 are arranged in the upper-layer region 40. The circuit blocks 41 and 42 are the circuit blocks of the same size, in which arrangement candidate regions 41a and 42a are generated, respectively. Because these arrangement candidate regions 41a and 42a are in contact with each other, these are set as the dummy pattern arrangement regions in step S43 illustrated in FIG. 15. Therefore, as illustrated in FIG. 17, a dummy pattern 44 is arranged in a portion formed by joining the arrangement candidate regions 41a and 42a.

(Second Layout Example)

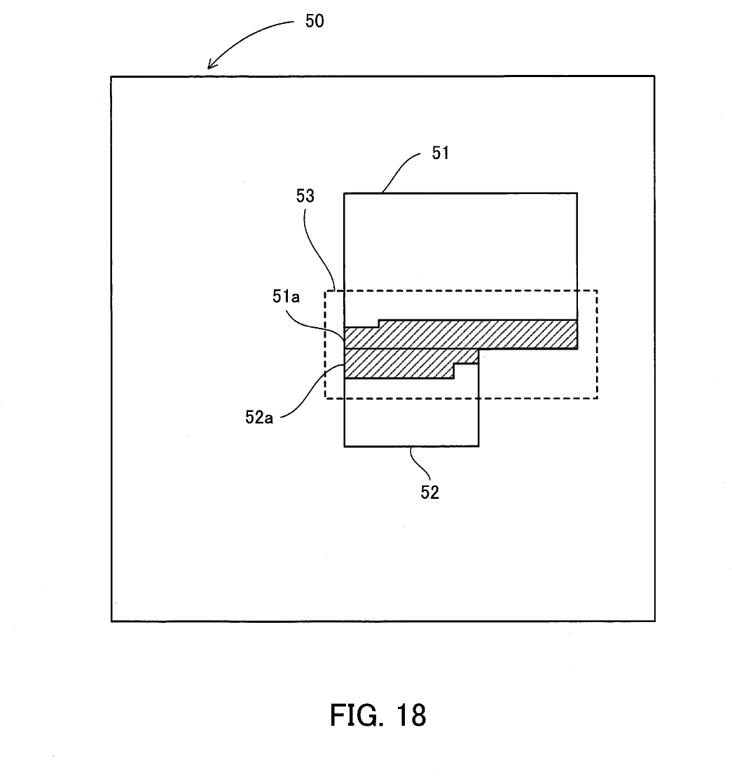

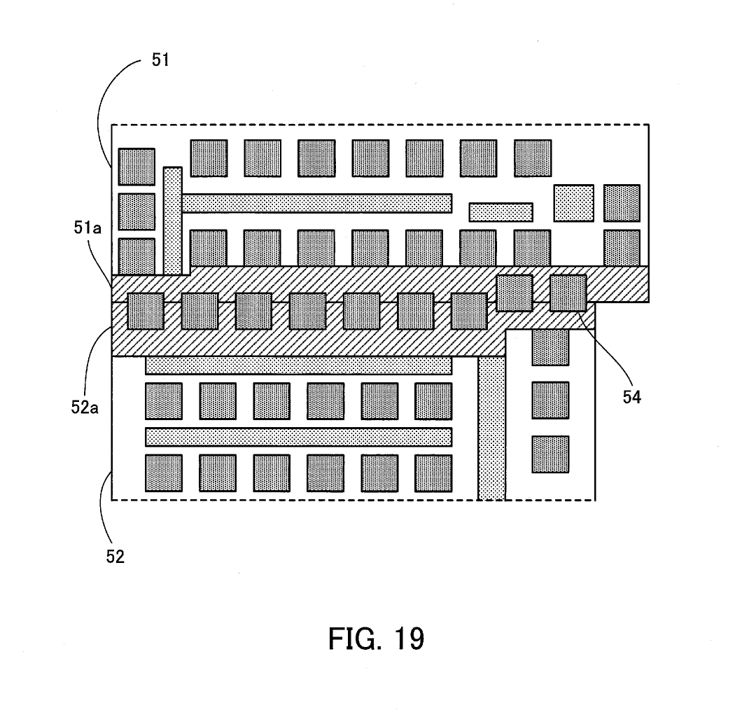

FIG. 18 illustrates a second layout example of an upper-layer region, and FIG. 19 is a partially enlarged view of FIG. 18. Note that FIG. 19 is an enlarged view of a region 53 illustrated in FIG. 18. In an upper-layer region 50 illustrated in FIG. 18, the illustration of patterns (circuit pattern and dummy pattern) is omitted.

As illustrated in FIG. 18, circuit blocks 51 and 52 are arranged in the upper-layer region 50. The circuit blocks 51 and 52 are the circuit blocks each having a different size, in which arrangement candidate regions 51a and 52a are generated, respectively. Because these arrangement candidate regions 51a and 52a are in contact with each other, these are set as the dummy pattern arrangement regions in step S43 illustrated in FIG. 15, as with the first layout example. Therefore, as illustrated in FIG. 19, a dummy pattern 54 is arranged in a portion formed by joining the arrangement candidate regions 51a and 5a.

Note that, upon completion of the arrangement of a dummy pattern in step S33, the arrangement candidate regions may be deleted from the design data 4f.

In the design processing as described above, the processor 21 may display the design data that is generated during the course of design, on the screen of the monitor 24a (see FIG. 4). Hereinafter, two examples of displaying on the screen of the monitor 24a are described.

(First Example of Display)

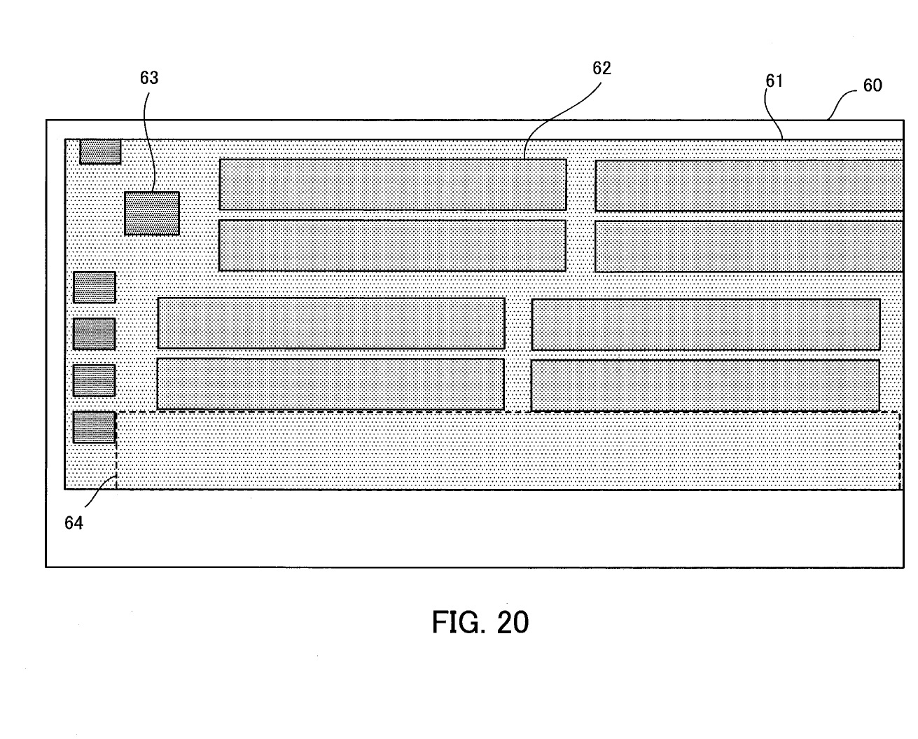

FIG. 20 illustrates a first example of displaying design data on a screen of a monitor.

In a screen 60 illustrated in FIG. 20, there are displayed a circuit block 61 and a wiring pattern 62 and dummy pattern 63 arranged in the circuit block 61, the circuit block 61, wiring pattern 62, and dummy pattern 63 being included in the design data 4d (see FIG. 5). Furthermore, an arrangement candidate region 64 generated in a boundary portion of the circuit block 61 is displayed.

(Second Example of Display)

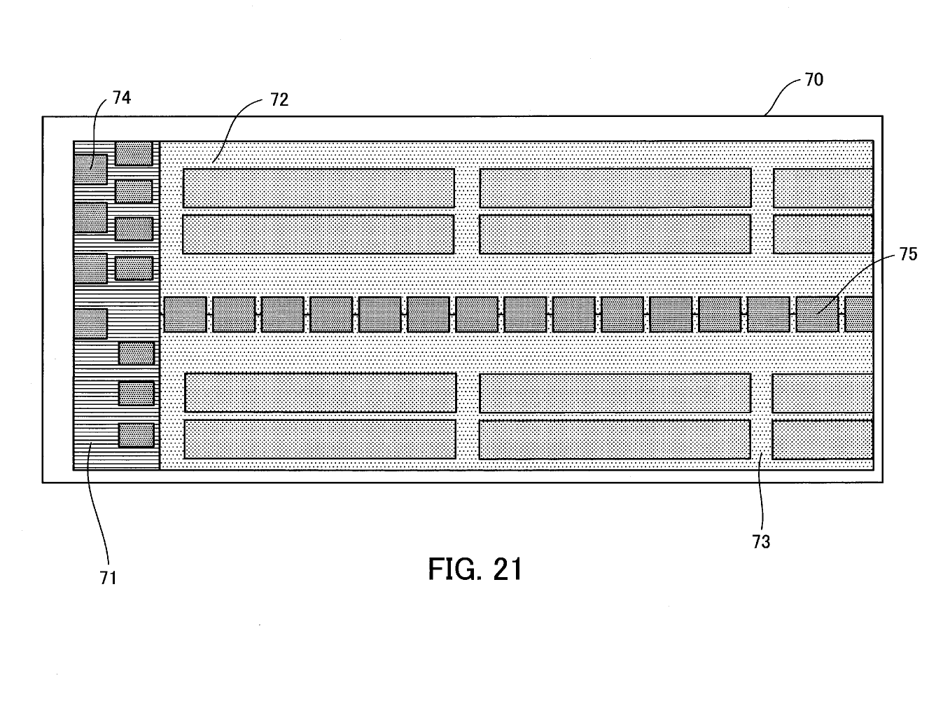

FIG. 21 illustrates a second example of displaying design data on a screen of a monitor.

In a screen 70 illustrated in FIG. 21, there are displayed an upper-layer region 71 and circuit blocks 72 and 73 and dummy pattern 74 arranged in the upper-layer region 71, the upper-layer region 71, circuit blocks 72 and 73, and dummy pattern 74 being included in the design data 4f (see FIG. 5). Furthermore, a dummy pattern 75 is arranged in a portion at which the circuit blocks 72 and 73 are in contact with each other.

Even with the design method of the second embodiment as described above, an effect similar to the effect of the design method of the first embodiment is obtained.

Moreover, in the design method of the second embodiment, when a composite pattern, which is generated by the processor 21 enlarging a pattern by a half of the check value and combining the resulting pattern, does not exceed a circuit block boundary, the processor 21 shrinks the composite pattern by a half of the check value to generate a composite pattern. Then, the processor 21 sets an arrangement candidate region between the composite pattern and the circuit block boundary, so that an arrangement candidate region corresponding to various arrangements and shapes of the pattern may be generated.

Furthermore, in the design method of the second embodiment, when the processor 21 selects an arrangement candidate region one by one and the selected arrangement candidate region does not contact another arrangement candidate region, the processor 21 excludes the selected arrangement candidate region from the candidate for arranging a dummy pattern. As a result, the processing time in arranging a dummy pattern in an arrangement candidate region may be reduced and the design period may be reduced further.

According to the design method, design apparatus, and program of the disclosure, the design period may be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A design method comprising:
arranging, by a processor, a first dummy pattern in each of a plurality of circuit blocks of a first layer included in hierarchical design data of a semiconductor device;
setting, by the processor, an arrangement candidate region that is a candidate for arranging a second dummy pattern in a first region, which is located between a circuit block boundary and the first dummy pattern and in which the first dummy pattern is not arranged, in each of the plurality of circuit blocks;
arranging, by the processor, the plurality of circuit blocks in a second region of a second layer higher than the first layer; and
arranging, by the processor, the second dummy pattern in a portion formed by joining a first arrangement candidate region of a first circuit block and a second arrangement candidate region of a second circuit block, the first arrangement candidate region and the second arrangement candidate region being in contact with each other, among arrangement candidate regions of the plurality of circuit blocks arranged in the second region.

2. The design method according to claim 1, further comprising determining, by the processor, whether or not to set the arrangement candidate region in the first region, based on an allowable maximum width defined by a rule in a region in which there is not a circuit pattern or the first dummy pattern included in each of the plurality of circuit blocks.

3. The design method according to claim 2, further comprising:
generating, by the processor, a first composite pattern by enlarging the circuit pattern and the dummy pattern by a half of the maximum width and combining the resulting circuit pattern and dummy pattern; and
when the first composite pattern does not exceed the circuit block boundary, generating, by the processor, a second composite pattern by shrinking the first composite pattern by a half of the maximum width, and setting, by the processor, the arrangement candidate region between the second composite pattern and the circuit block boundary.

4. The design method according to claim 1, further comprising selecting, by the processor, the arrangement candidate region one by one, and when a selected third arrangement candidate region is not in contact with another arrangement candidate region, excluding the third arrangement candidate region from a candidate for arranging the second dummy pattern.

5. A design apparatus comprising a processor configured to perform a procedure including:
arranging a first dummy pattern in each of a plurality of circuit blocks of a first layer included in hierarchical design data of a semiconductor device;
setting an arrangement candidate region that is a candidate for arranging a second dummy pattern in a first region, which is located between a circuit block boundary and the first dummy pattern and in which the first dummy pattern is not arranged, in each of the plurality of circuit blocks;
arranging the plurality of circuit blocks in a second region of a second layer higher than the first layer; and
arranging the second dummy pattern in a portion formed by joining a first arrangement candidate region of a first circuit block and a second arrangement candidate region of a second circuit block, the first arrangement candidate region and the second arrangement candidate region being in contact with each other, among arrangement candidate regions of the plurality of circuit blocks arranged in the second region.

6. A non-transitory computer-readable storage medium storing a computer program that causes a computer to perform a procedure comprising:
arranging a first dummy pattern in each of a plurality of circuit blocks of a first layer included in hierarchical design data of a semiconductor device;
setting an arrangement candidate region that is a candidate for arranging a second dummy pattern in a first region, which is located between a circuit block boundary and the first dummy pattern and in which the first dummy pattern is not arranged, in each of the plurality of circuit blocks;
arranging the plurality of circuit blocks in a second region of a second layer higher than the first layer; and
arranging the second dummy pattern in a portion formed by joining a first arrangement candidate region of a first circuit block and a second arrangement candidate region of a second circuit block, the first arrangement candidate region and the second arrangement candidate region being in contact with each other, among arrangement candidate regions of the plurality of circuit blocks arranged in the second region.
